(19) United States
(12) Patent Application Publication
(10) Pub. No.: US 2018/0020866 A1
(43) Pub. Date: Jan. 25, 2018

(54) PORTABLE COFFEE MAKER ASSEMBLY

(71) Applicant: Kirby Cornett, Georgetown, KY (US)

(72) Inventor: Kirby Cornett, Georgetown, KY (US)

(21) Appl. No.: 15/217,073

(22) Filed: Jul. 22, 2016

(51) Int. Cl. A47J 31/00; A47J 31/40; A47J 31/34

(52) U.S. Cl. CPC A47J 31/005; A47J 31/34; A47J 31/407

(57) ABSTRACT

A portable coffee maker assembly for brewing coffee or other hot beverages from a pod from a portable device includes a base housing that includes a brewing compartment and two opposing transporting covers which may be selectively secured together into a transporting configuration or separated into a brewing configuration. The brewing compartment is operative to draws water stored in a water compartment member positioned thereon into the brewing conduit and direct the water to a pod receptacle positioned thereon, passing through an integrated heating element along the way. In this regard, heated water may be introduced into a coffee pod positioned in the pod receptacle and then dispensed into a drinking receptacle.

### BACKGROUND OF THE INVENTION

### Field of the Invention

This invention relates generally to mobile hot beverage infusers and, more particularly, to a battery operated coffee maker built into a carrying case.

### Description of the Prior Art

The use and design of conventional single serve pod coffee makers is well known. Typically, such pod coffee makers operate to draw water from a internal tank, heat the water and push the heated water through a pod containing ground coffee. A problem which still exists, however, is that most single serve pod coffee makers are for use in a fixed, indoor location and are not particularly suited for portability. Thus, there remains a need for a portable coffee maker assembly having a transporting housing and a rechargeable onboard power source to allow it to be used in substantially any environment. It would be helpful if such a portable coffee maker assembly included a plurality of refillable water containers to allow for easy transport of the water for use in making coffee. It would be additionally desirable for such a portable coffee maker assembly to heat water by directing the water past a heating element so as to minimize the consumption of electrical power.

The Applicant's invention described herein provides for a portable coffee maker assembly adapted to allow a user to brew a cup of coffee from a portable device. The primary components in Applicant's portable coffee maker assembly are a housing with a brewing compartment, transporting covers, and a handle. When in operation, the portable coffee maker assembly provides a portable brewing interface capable of providing several cups of coffee in a single deployment. As a result, many of the limitations imposed by prior art structures are removed.

### SUMMARY OF THE INVENTION

A portable coffee maker assembly for brewing coffee or other hot beverages from a pod from a portable device. The portable coffee maker assembly of the instant disclosure comprises a base housing that includes a brewing compartment and two opposing transporting covers which may be selectively secured together into a transporting configuration or separated into a brewing configuration. The brewing compartment is operative to draws water stored in a water compartment member positioned thereon into the brewing conduit and direct the water to a pod receptacle positioned thereon, passing through an integrated heating element along the way. In this regard, heated water may be introduced into a coffee pod positioned in the pod receptacle and then dispensed into a drinking receptacle.

It is an object of this invention to provide a portable coffee maker assembly having a transporting housing and a rechargeable onboard power source to allow it to be used in substantially any environment.

It is another object of this invention to provide a portable coffee maker assembly which includes a plurality of refillable water containers to allow for easy transport of the water for use in making coffee.

It is yet another object of this invention to provide a portable coffee maker assembly operative to heat water by directing the water past a heating element so as to minimize the consumption of electrical power.

These and other objects will be apparent to one of skill in the art.

### BRIEF DESCRIPTION OF THE DRAWINGS

FIG. 1 is a front perspective view of a portable coffee maker assembly built in accordance with the present invention in a transporting configuration.

FIG. 2 is a rear perspective view of a portable coffee maker assembly built in accordance with the present invention in a transporting configuration.

FIG. 3 is a front perspective view of a portable coffee maker assembly built in accordance with the present invention in a brewing configuration.

FIG. 4 is a block diagram showing the operative brewing components of a portable coffee maker assembly built in accordance with the present invention.

### DETAILED DESCRIPTION OF THE INVENTION

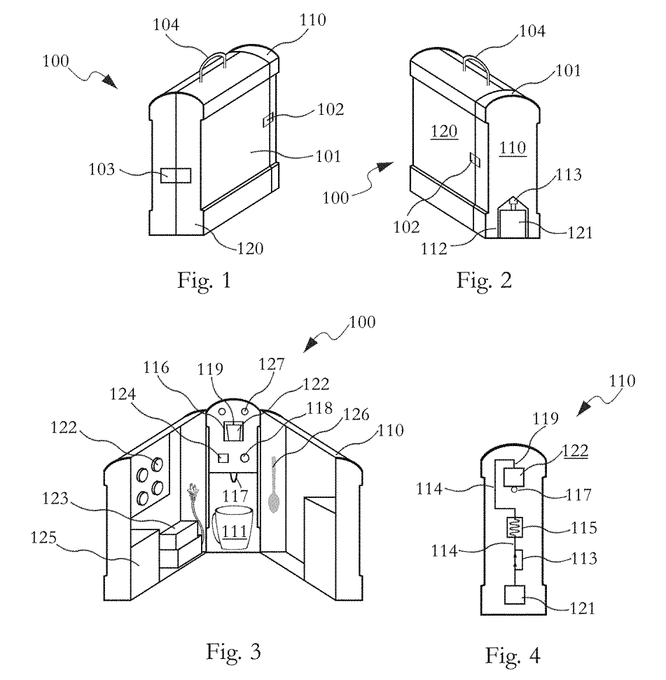

Referring now to the drawings and in particular FIGS. 1, 2, 3, and 4, a portable coffee maker assembly 100 is shown as a base housing 101 that includes a brewing compartment 110 and two opposing transporting covers 120. The brewing compartment 110 and transporting covers 120 of the base housing 101 may be fastened together in a transporting configuration, as illustrated in FIGS. 1 and 2, and separated apart into a brewing configuration, as illustrated in FIG. 3. When in the transporting configuration, the brewing compartment 110 and transporting covers 120 are secured together with a side latching mechanism 102, with the transporting covers 120 secured to one another with a front latching mechanism 103. By securing the three components together, the base housing 101 may be easily carried around in one piece with a user simply grasping a handle 104.

In one embodiment, both the side latching mechanisms 102 (one for each transporting cover 120) as well as the front latching mechanism 103 are draw latches.

When it is desired to brew a cup (or multiple cups) of coffee, the brewing compartment 110 and transporting covers 120 may be detached from one another and positioned to the brewing configuration so as to expose the front surface of the brewing compartment 110 defined by where a cup 111 (or other beverage container) may be placed to receive brewed coffee. Internally, the brewing compartment 110 includes a water compartment slot 112, a water pump 113, a brewing conduit 114, a heating element 115, a pod receptacle 116, and a coffee dispensing spout 117. In order to brew a cup of coffee, a user places their cup 111 under the dispensing spout 117 on the front of the brewing compartment 110, placing a water compartment member 121 in the water compartment slot 112, placing a coffee pod 122 into the pod receptacle 116, and activating a brewing cycle by mechanically engaging an activation button 118. Once the activation button 118 is engaged, the water pump 113 draws water stored in the water compartment member 121 into the brewing conduit 114. The brewing conduit 114 defines in one embodiment a stainless steel tube which extends from the water compartment slot 112 to the pod receptacle 116, passing through the heating element 115 along the way. In this regard, water drawn into the brewing conduit 114 from the water compartment member 121 is heated as it is directed towards the pod receptacle 116 (through the same mechanism as a tankless water heater) and into a coffee pod 122 positioned in the pod receptacle 116.

In one embodiment, the brewing conduit 114 includes a pressurizing spout 119 at its end where hot water empties therefrom into the coffee pod 112. In one embodiment, the pressurizing spout 119 defines a needle with a narrowing internal channel and constructed of stainless steel that pressurizes the water exiting the brewing conduit by forcing it to pass through the narrowing channel.

The portable coffee maker assembly 100 operates to direct water into the coffee pod 122 and dispense coffee from the coffee pod 122 into the cup 111 in substantially the same manner as conventional pod coffee makers. As such, in one embodiment, placing the coffee pod 122 into the pod receptacle 116 engages the dispensing spout 117 with the bottom of the coffee pod and engaging the activation button 118 causes the pressurizing spout 119 to be inserted into the top of the coffee pod 122.

In one embodiment, the interior of the transporting covers 120 are employed for storage space for various items related to brewing. As such, extra coffee pods 122, an on board power source 123, extra water compartment members 121, a sugar and creamer holder 125, and a spoon 126 may be stored thereon.

It is contemplated that in order to supply electrical power to the components of the brewing compartment 110, the on board power source 123 may be plugged into a power jack 124 on the brewing compartment 110.

In one embodiment, a pair of lighting elements 127 are positioned on the brewing compartment 110 so as to provide illumination and allow the portable coffee maker assembly 100 to be used in poorly lit areas.

In one embodiment, the on board power source 123 defines a 24 volt rechargeable battery.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A portable coffee maker assembly, comprising:
a base housing having a brewing compartment and at least one transporting cover, wherein said base housing includes an on board power source adapted to selectively supply electrical power to the brewing compartment, a water compartment member adapted to hold a supply of water, and a beverage container;
wherein said brewing compartment includes a brewing conduit, water pump, heating element, and a pod receptacle and said water pump is configured to draw water from the water compartment member and direct the water past the heating element and into the pod receptacle through the brewing conduit, thereby enabling the water drawn in to be introduced hot to a coffee pod positioned in the pod receptacle;
wherein said pod receptacle is integrated with a dispensing spout adapted to receive liquid previously introduced to the coffee pod and dispense received liquid into the beverage container; and
wherein base housing is movable between a transporting configuration in which the said brewing compartment and at least one transporting cover are secured together and a brewing configuration in which said brewing compartment and at least one transporting cover are separated.

2. The portable coffee maker assembly of claim 1, wherein said wherein said brewing compartment additionally includes a pressurizing spout integrated with the brewing conduit and adapted to pressurize water being directed into the pod receptacle.

3. The portable coffee maker assembly of claim 2, wherein said on board power source is adapted plug into a power jack on the brewing compartment and thereby supply electrical power to the brewing compartment.

4. The portable coffee maker assembly of claim 1, wherein said on board power source is adapted plug into a power jack on the brewing compartment and thereby supply electrical power to the brewing compartment.

5. The portable coffee maker assembly of claim 1, additionally comprising at least one lighting element integrated with the base housing, wherein said lighting elements are operative to supply illumination to the brewing compartment.
